(19) United States
(12) Patent Application Publication
(10) Pub. No.: US 2025/0184705 A1
(43) Pub. Date: Jun. 5, 2025

(54) AUTOMATED CREATION OF RICH NOTIFICATIONS FOR EMERGENCY DISTRIBUTION

(71) Applicant: T-MOBILE INNOVATIONS LLC, Overland Park, KS (US)

(72) Inventor: Kade Lee SCOTT, McKinney, TX (US)

(21) Appl. No.: 18/528,363

(22) Filed: Dec. 4, 2023

(51) Int. Cl. H04W 4/90; H04W 68/06

(52) U.S. Cl. CPC H04W 4/90; H04W 68/06

(57) ABSTRACT

Systems and methods are provided for providing network notifications of triggering events. Triggering events can be any event identified by one or more sensors that meets predetermined triggering event criteria such that a notification should be communicated via a telecommunications network. The present disclosure describes aspects where triggering events (e.g., natural disasters, mass casualty events, etc.) are detected and all user devices within a predetermined area of the triggering event are notified via the telecommunications network, leveraging network data of user device locations.

### SUMMARY

A high-level overview of various aspects of the present technology is provided in this section to introduce a selection of concepts that are further described below in the detailed description section of this disclosure. This summary is not intended to identify key or essential features of the claimed subject matter, nor is it intended to be used as an aid in isolation to determine the scope of the claimed subject matter.

In aspects set forth herein, systems and methods are provided for providing rich notifications to network nodes. More particularly, in aspects set forth herein, systems and methods enable automatic initiation of a rich notifications to be distributed to one or more network nodes upon detection of a triggering event. The triggering event causes creation of a distribution list that includes one or more network nodes relevant to the triggering event, such that the notification is automatically communicated to the one or more network nodes.

### BRIEF DESCRIPTION OF THE SEVERAL VIEWS OF THE DRAWINGS

Implementations of the present disclosure are described in detail below with reference to the attached drawing figures, wherein:

FIG. 1 depicts a diagram of an exemplary network environment in which implementations of the present disclosure may be employed, in accordance with aspects herein;

FIG. 2 depicts a diagram of an exemplary network environment in which implementations of the present disclosure may be employed, in accordance with aspects herein;

FIG. 3 depicts a flow diagram of a method for providing network notifications, in accordance with aspects herein;

FIG. 4 depicts a flow diagram of a method for providing network notifications, in accordance with aspects herein; and

FIG. 5 depicts a diagram of an exemplary computing environment suitable for use in implementations of the present disclosure, in accordance with aspects herein.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Throughout this disclosure, several acronyms and shorthand notations are employed to aid the understanding of certain concepts pertaining to the associated system and services. These acronyms and shorthand notations are intended to help provide an easy methodology of communicating the ideas expressed herein and are not meant to limit the scope of embodiments described in the present disclosure. The following is a list of these acronyms:
3G Third-Generation Wireless Technology
4G Fourth-Generation Cellular Communication System
5G Fifth-Generation Cellular Communication System
AMF Access & Mobility Management Function
APN Access Point Name
CD-ROM Compact Disk Read Only Memory
CDMA Code Division Multiple Access
eNodeB Evolved Node B
GIS Geographic/Geographical/Geospatial Information System
gNodeB Next Generation Node B
GPRS General Packet Radio Service
GSM Global System for Mobile communications
iDEN Integrated Digital Enhanced Network
DVD Digital Versatile Discs
EEPROM Electrically Erasable Programmable Read Only Memory
LED Light Emitting Diode
LTE Long Term Evolution
MIMO Multiple Input Multiple Output
MD Mobile Device
PC Personal Computer
PCF Policy Control Function
PCS Personal Communications Service
PDA Personal Digital Assistant
RAM Random Access Memory
RET Remote Electrical Tilt
RF Radio-Frequency
RFI Radio-Frequency Interference
R/N Relay Node
ROM Read Only Memory
SINR Transmission-to-Interference-Plus-Noise Ratio
SMF Session Management Function
SNR Transmission-to-noise ratio
SON Self-Organizing Networks
TDMA Time Division Multiple Access
TXRU Transceiver (or Transceiver Unit)
UDM Unified Data Management Function
UDR Unified Data Repository
UE User Equipment
UPF User Plane Function

Further, various technical terms are used throughout this description. An illustrative resource that fleshes out various aspects of these terms can be found in Newton's Telecom Dictionary, 32d Edition (2022).

As used herein, the term “node” is used to refer to network access technology for the provision of wireless telecommunication services from a base station to one or more electronic devices, such as an eNodeB, gNodeB, etc. Node may also be used herein to refer to communication endpoint such as user equipment (UE) (e.g., mobile phone).

Embodiments of the present technology may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions—including data structures and program modules—in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

By way of background, a traditional telecommunications network employs a plurality of base stations (i.e., cell sites, cell towers) to provide network coverage. The base stations are employed to broadcast and transmit transmissions to user devices of the telecommunications network. An access point may be considered to be a portion of a base station that may comprise an antenna, a radio, and/or a controller.

As employed herein, a UE (also referenced herein as a user device) or WCD can include any device employed by an end-user to communicate with a wireless telecommunications network. A UE can include a mobile device, a mobile broadband adapter, or any other communications device employed to communicate with the wireless telecommunications network. A UE, as one of ordinary skill in the art may appreciate, generally includes one or more antenna coupled to a radio for exchanging (e.g., transmitting and receiving) transmissions with a nearby base station.

In conventional cellular communications technology, a 5G telecommunications network comprises a 5G Core Network (5GC) and a gNB. The 5GC architecture, as known to those in the art, relies on a Service-Based Architecture (SBA) framework where the architecture elements are defined in terms of Network Functions (NF) rather than by traditional network entities. Using interfaces of a common framework, any NF can offer its services to other NFs that are permitted to make use of their functions. At times, the network interfaces can experience complete failures, degradations, and the like. This compromises the ability of other NFs to obtain necessary data to establish reliable sessions for UEs.

The present disclosure is directed to providing network notifications to network nodes. More particularly, in aspects set forth herein, systems and methods enable automatic initiation of a network notification to be distributed to one or more network nodes upon detection of a triggering event. The triggering event causes creation of a distribution list that includes one or more network nodes relevant to the triggering event, such that the notification is automatically communicated to the one or more network nodes, including one or more UEs.

Accordingly, a first aspect of the present disclosure is directed to a system for providing network notifications. The system comprises one or more processors and one or more computer-readable media storing computer-usable instructions that, when executed by the one or more processors, cause the one or more processors to: receive an indication of a triggering event, identify a location of the triggering event, create a distribution list of one or more network nodes within a predetermined distance from the location of the triggering event to receive a notification of the triggering event, and communicate the notification to the one or more network nodes.

A second aspect of the present disclosure is directed to a method for providing network notifications. The method comprises receiving an indication of a triggering event, identifying a location of the triggering event, creating a distribution list of one or more network nodes within a predetermined distance from the location of the triggering event to receive a notification of the triggering event, and communicating the notification to the one or more network nodes.

Another aspect of the present disclosure is directed to a method for providing network notifications. The method comprises receiving an indication of a triggering event, identifying a location of the triggering event, identifying a first area within a first predetermined distance of the triggering event, creating a distribution list of a first set of one or more network nodes in the first area, communicating a first notification of the triggering event to the first set of one or more network nodes in the first area, identifying a second area within a second predetermined distance of the triggering event, creating a second distribution list with a second set of one or more network nodes in the second area, and communicating a second notification of the triggering event to the second set of one or more network nodes in the second area.

By way of background, traditional notification systems only provide an all or nothing approach. In other words, a notification system notifies everyone or no one typically. Additionally, current notification systems are manually initiated versus automatically initiated based on network sensor data. For instance, the National Weather Service sends notifications out when an individual (e.g., a meteorologist) identifies a severe weather threat. Amber Alerts, while location specific, are communicated with an individual manually inputs information regarding an abduction event and initiates the alert process. Furthermore, many other alert systems are opt-in systems where a user has to manually opt in for alerts. None of these existing systems offer an automated approach (based on network sensor data) that distributes relevant notifications to user devices (e.g., network nodes) within a predetermined area.

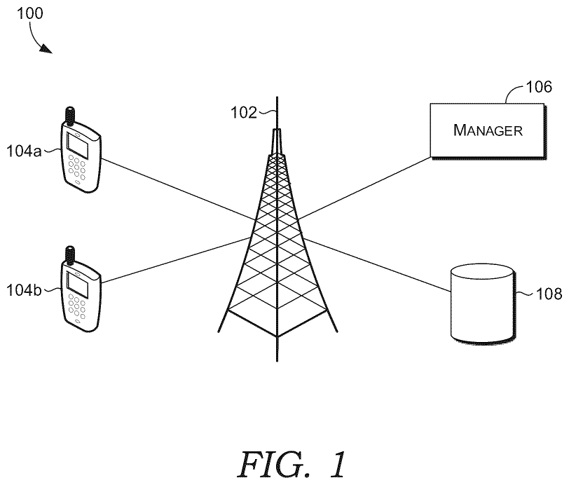

Turning to FIG. 1, a network environment suitable for use in implementing embodiments of the present disclosure is provided. Such a network environment is illustrated and designated generally as network environment 100. Network environment 100 is but one example of a suitable network environment and is not intended to suggest any limitation as to the scope of use or functionality of the disclosure. Neither should the network environment 100 be interpreted as having any dependency or requirement relating to any one or combination of components illustrated.

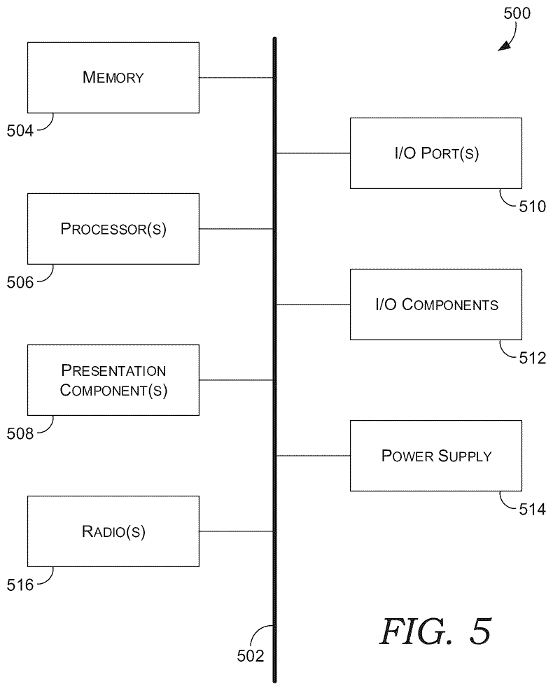

A network cell may comprise a base station 102 to facilitate wireless communication between a communications device within the network cell, such as communications device 500 described with respect to FIG. 5, and a network. As shown in FIG. 1, communications device may be UE 104a, UE 104b, among others not shown. For simplicity, reference to UE 104a will be in the singular nature but also includes UE 104b or any other UEs not shown. The actions/roles described as relevant to UE 104a apply with equal force to UE 104b. In the network environment 100, UE 104a may communicate with other devices, such as mobile devices, servers, etc. The UE 104a may take on a variety of forms, such as a personal computer, a laptop computer, a tablet, a netbook, a mobile phone, a Smart phone, a personal digital assistant, or any other device capable of communicating with other devices. For example, the UE 104a may take on any form such as, for example, a mobile device or any other computing device capable of wirelessly communication with the other devices using a network. Makers of illustrative devices include, for example, Research in Motion, Creative Technologies Corp., Samsung, Apple Computer, and the like. A device can include, for example, a display(s), a power source(s) (e.g., a battery), a data store(s), a speaker(s), memory, a buffer(s), and the like. In embodiments, UE 104a comprises a wireless or mobile device with which a wireless telecommunication network(s) can be utilized for communication (e.g., voice and/or data communication). In this regard, the UE 104a can be any mobile computing device that communicates by way of, for example, a 5G network.

The UE 104a may utilize a network to communicate with other computing devices (e.g., mobile device(s), a server(s), a personal computer(s), etc.). In embodiments, the network is a telecommunications network, or a portion thereof. A telecommunications network might include an array of devices or components, some of which are not shown so as to not obscure more relevant aspects of the invention. Components such as terminals, links, and nodes (as well as other components) may provide connectivity in some embodiments. The network may include multiple networks. The network may be part of a telecommunications network that connects subscribers to their immediate service provider. In embodiments, the network is associated with a telecommunications provider that provides services to user devices, such as UE 102. For example, the network may provide voice services to user devices or corresponding users that are registered or subscribed to utilize the services provided by a telecommunications provider.

The network can include one or more base stations, such as base station 102. The base station 102 can communicate with any number of UEs within its designated coverage area. The base station 102 also communicates with a manager 106. The manager 106 can be a part of the network or a distributed computing device. The manager 106 and base station 102 are also in communicated with one or more sensors or sensor arrays (not shown). The one or more sensors or sensor arrays can be a variety of sensors known in the art today such as, but not limited to, acoustic sensors, camera sensors, weather sensors, pressure sensors, water level sensors, and the like. The sensor(s)/sensor array can be used to detect triggering events. A triggering event, as used herein, is an event that causes activation of a sensor by way of satisfying predetermined triggering event criteria. For instance, each sensor-type (e.g., acoustic, visual, water level, etc.) can be associated with a set of one or more predetermined criteria that should be met before a triggering event is identified. In the case of an acoustic sensor, the predetermined criteria may include a sound above a threshold decibel level. Alternatively, the predetermined criteria may include a plurality of sounds at the same decibel level that occur within a predetermined period of time of one another. Similarly, a camera sensor may have predetermined criteria that requires a visual set of circumstances that happen in a specific sequence, within a set time frame, at a certain rate of speed, or the like. Sensors can also be trained to be activated with various triggering events. For instance, a camera can be trained to identify a car accident by way of training data to create a machine learned model that identifies various traffic incidents (e.g., accidents, construction, debris in the road, etc.).

Once activated, the sensors can initiate a network notification process. The sensors can initially contact either the manager 106 associated with the base station 102, or communicate directly with the base station 102. As previously mentioned, the manager 106 is part of/integrated into the telecommunications network and can make determinations on behalf of the base station 102 such that they act in concert with one another. The sensors can notify the network (i.e., the base station 102 or the manager 106) that a triggering event has been detected (i.e., triggering event criteria is satisfied).

Once the triggering event is identified and communicated to the network from the sensor or sensor array, the network can identify a location of the triggering event. Various technologies can be used to identify an exact location of a triggering event including, but not limited to, cell tower triangulation. Based on the location of the triggering event, a surrounding location/area within a predetermined distance (e.g., a five mile radius of the triggering event, etc.) from the location of the triggering event can be identified. The network can determine one or more network nodes (user devices) that are within the predetermined distance from the location of the triggering event and create a distribution list of the network nodes that should receive a notification of the triggering event. The manager 106, for instance, can create the distribution list and communicate a rich notification to the one or more base stations for communication to one or more user devices. A rich notification or notification, as used herein, refers generally to a notification to an endpoint that identifies a triggering event is within a predetermined distance for the user and an action that the user should take. In order to avoid unnecessary alarm or communication of private information, the notification may include a specific triggering event in some situations (e.g., a shooting, a wildfire, a flood, a car accident, etc.) or may include a general triggering event-type (e.g., a natural disaster, a mass casualty event, etc.). The notification may also include a location of the triggering event (or the triggering event-type), a time of the triggering event, and a recommended action to take based on the triggering event.

The use of the predetermined distance to communicate notifications ensures that only user devices that are impacted (or likely to be impacted) by the triggering event are notified. Alert fatigue is an increasing problem and natural disasters, emergency situations, etc., tend to be taken less seriously if an individual is not directly impacted by it (e.g., a user's house is not in the path of a tornado, a shooting has occurred in the neighboring town, etc.).

The recommended action the user should take ensures that users are notified of the desired course of action based on the triggering event. For instance, triggering events (or triggering event-types) may be associated with template notifications with varying actions to be taken such as evacuation when flood waters reach a certain level, evacuation when a wildfire is within a predetermined distance and your location is in the predicted path of the wildfire, remain alert when a wildfire is within a second predetermined distance and your location is near the predicted path of the wildfire but not directly within the path, shelter in place when a shooting event is identified in your area but you are not in the same location of the event, etc. These personalized actions (tailored to triggering events, triggering event locations, and locations of user devices) ensure that users are aware and ensure immediate delivery of actions to a relevant set of users.

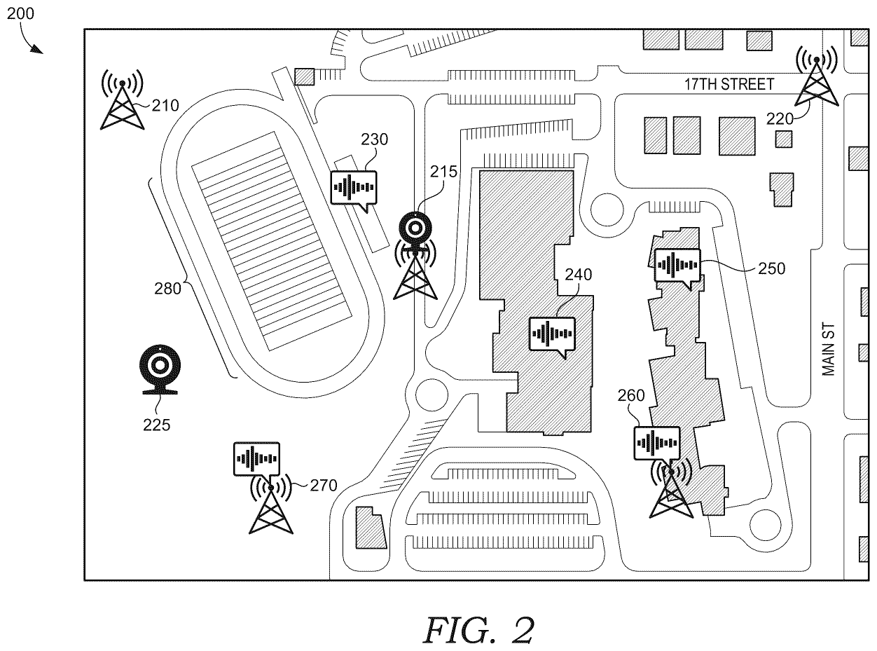

By way of example, and with reference to FIG. 2, a network environment 200 is illustrated. As is evident, environment 200 provides an exemplary area where the present system is in use. As is shown, the environment includes a base station 210, a base station having an affixed camera system 215, a base station 220, a stand-alone camera 225, a stand-alone acoustic sensor 230, a stand-alone acoustic sensor 240, a stand-alone acoustic sensor 250, a base station having an affixed acoustic system 260, and a base station having an affixed acoustic system 270. This is meant to be exemplary in nature and not limit a location or number of exemplary sensor systems that may be utilized in the present disclosure. In aspects, noises that meet the predetermined threshold criteria for an acoustic sensor can be identified by either a stand-alone acoustic sensor (such as stand-alone acoustic sensor 230) or by an acoustic sensor affixed to a base station (such as base station having an affixed acoustic system 270). Assuming a sound is detected from area 280 (i.e., the football field), each of the acoustic sensor 230 or the acoustic system affixed to the base station 270 could detect the sound and determine if the sound meets the predetermined criteria to qualify as a triggering event. The base station itself or an integrated manager could make the determination on whether a triggering event is detected. Alternatively, the sensors, on their own, can determine a triggering event is detected and communicate the detection to the base station and/or manager.

Once the triggering event is detected in area 280, the location of the triggering event is identified by the base station having the affixed acoustic sensor 270 or any other base station that received a notification of the triggering event. In embodiments, the triggering event is communicated to a nearest base station to the sensor/sensor array. In alternate embodiments, the triggering event is communicated to any number of base stations within a predetermined distance of the sensor that detected the triggering event. The base station(s) having received the indication of the triggering event determines the location of the triggering event. Once the location of the triggering event is identified as area 280, the base station determines one or more network nodes to notify of the triggering event. The one or more network nodes can include one or more user devices (UEs) within a predetermined distance from the triggering event. The one or more network nodes can also include one or more other base stations that are within a predetermined distance of the triggering event. As shown, base station having an affixed camera system 215 is near area 280. If base station 270 detected the sound, base station 215 may be notified of the sound as it likely includes one or more UEs that should be notified of the triggering event as they are within a predetermined distance from the triggering event.

Additionally, the base station 270 may determine a surrounding area (i.e., an area that is within a second predetermined distance from the triggering event, further than the predetermined distance used for the initial notification) and a base station associated therewith. For example, assume that base station 220 is five miles from the triggering event/area 280. This may not satisfy the predetermined distance for initial notification to UEs, but may satisfy the second predetermined distance such that any UEs within the coverage area of base station 220 are notified. The notification by base station 220 may be subsequent to the initial notifications. Thus, the present system can utilize a prioritization hierarchy such that UEs within a first distance from the triggering event are notified at a first time and UEs within a second distance from the triggering event are notified at a second time after the first time.

Subsequent notifications may be sent to the impacted network nodes (e.g., UEs that received a prior notification) including an update on the triggering event, updated recommended actions, and the like. For instance, if a tornado changes paths such that a first set of UEs is no longer impacted, an updated notification could be sent advising that the recommended action is to remain weather aware rather than to seek shelter. Additionally, notifications with updates may be sent after a predetermined time period has elapsed such that individuals remain aware a threat is still present (or not).

Machine learning and artificial intelligence can also be leveraged to provide network notifications. For instance, the system can be trained to identify a car accident based on a sequence of events detected by a camera sensor. Additionally, intelligence can be utilized to predict a sequence of events based on input data. For instance, if a weather sensor detects a tornado at a first location, the system described herein can predict an estimated path of the tornado with an estimated arrival time for subsequent locations based on path direction, speed of travel, etc. Similarly, a path of a wildfire can be predicted based on wind speed, speed of travel, direction of travel, etc. These predictions can be utilized to identify a predicted affected area that may receive proactive notifications if they are likely to be impacted by the triggering event.

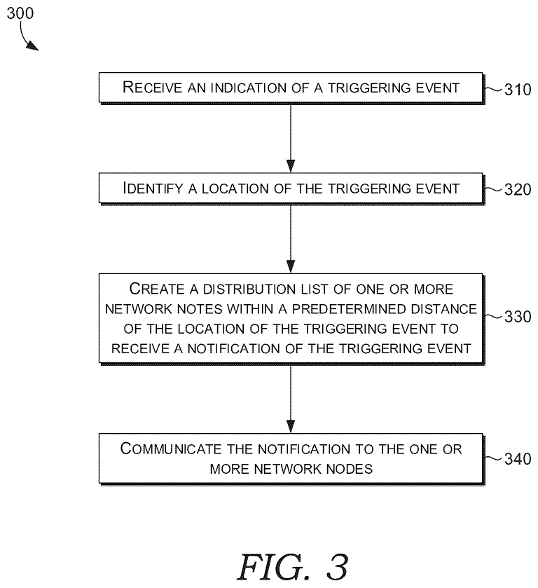

Turning to FIG. 3, a flow diagram 300 is provided illustrating a flow to provide network notifications. Initially, at block 310, an indication of a triggering event is received. The indication may be received at a telecommunications network from one or more sensors or sensor arrays. At block 320, a location of the triggering event is identified. A distribution list is created at block 330. The distribution list comprises one or more network nodes within a predetermined distance of the location of the triggering event such that the one or more network nodes receives a notification of the triggering event. The one or more network nodes can include additional base stations, UEs, and the like. At block 340, the notification is communicated to the one or more network nodes.

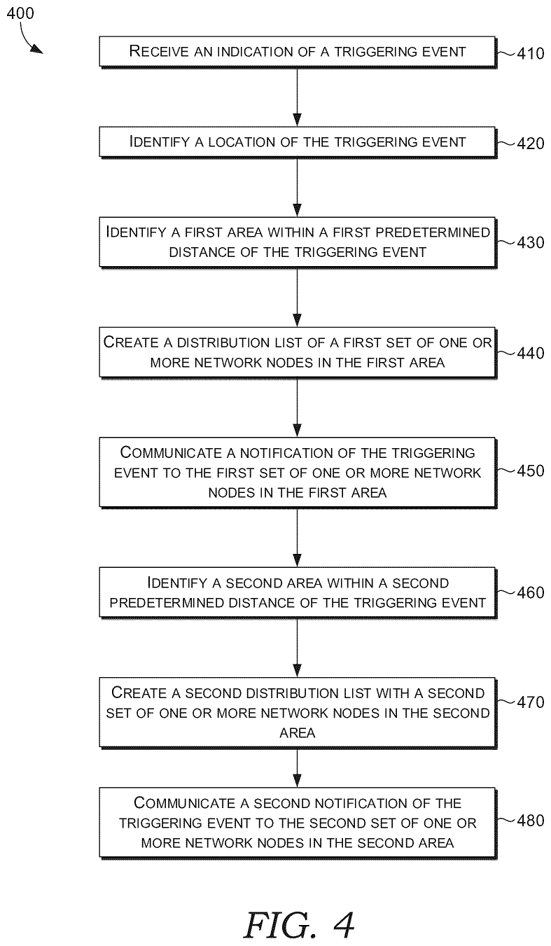

Referring to FIG. 4, a flow diagram 400 is provided illustrating a flow to provide network notifications. Initially, at block 410, an indication of a triggering event is received. The indication may be received at a telecommunications network from one or more sensors or sensor arrays. A location of the triggering event is identified at block 420. A first area within a first predetermined distance of the triggering event is identified at block 430 and a distribution list of a first set of one or more network nodes in the first area is created at block 440. A notification of the triggering event is communicated to the first set of one or more network nodes in the first area at block 450. A second area within a second predetermined distance of the triggering event is identified at block 460. The second predetermined distance is farther from the triggering event than the first predetermined distance. A second distribution list comprising a second set of one or more network nodes in the second area is created at block 470. A second notification of the triggering event is communicated to the second set of one or more network nodes in the second area at block 480. The second notification can be sent at a second time, subsequent to a first time in which the first notification was sent.

Referring to FIG., a block diagram of an exemplary computing device 00 suitable for use in implementations of the technology described herein is provided. In particular, the exemplary computer environment is shown and designated generally as computing device 500. Computing device 500 is but one example of a suitable computing environment and is not intended to suggest any limitation as to the scope of use or functionality of the invention. Neither should computing device 500 be interpreted as having any dependency or requirement relating to any one or combination of components illustrated. It should be noted that although some components in FIG. 6 are shown in the singular, they may be plural. For example, the computing device 500 might include multiple processors or multiple radios. In aspects, the computing device 500 may be a UE/WCD, or other user device, capable of two-way wireless communications with an access point. Some non-limiting examples of the computing device 500 include a cell phone, tablet, pager, personal electronic device, wearable electronic device, activity tracker, desktop computer, laptop, PC, and the like.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

As shown in FIG. 5, computing device 500 includes a bus 510 that directly or indirectly couples various components together, including memory 512, processor(s) 514, presentation component(s) 516 (if applicable), radio(s) 524, input/output (I/O) port(s) 518, input/output (I/O) component(s) 520, and power supply(s) 522. Although the components of FIG. 5 are shown with lines for the sake of clarity, in reality, delineating various components is not so clear, and metaphorically, the lines would more accurately be grey and fuzzy. For example, one may consider a presentation component such as a display device to be one of I/O components 520. Also, processors, such as one or more processors 514, have memory. The present disclosure hereof recognizes that such is the nature of the art, and reiterates that FIG. 5 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of the present disclosure and refer to “computer” or “computing device.”

Memory 512 may take the form of memory components described herein. Thus, further elaboration will not be provided here, but it should be noted that memory 512 may include any type of tangible medium that is capable of storing information, such as a database. A database may be any collection of records, data, and/or information. In one embodiment, memory 512 may include a set of embodied computer-executable instructions that, when executed, facilitate various functions or elements disclosed herein. These embodied instructions will variously be referred to as “instructions” or an “application” for short.

Processor 514 may actually be multiple processors that receive instructions and process them accordingly. Presentation component 516 may include a display, a speaker, and/or other components that may present information (e.g., a display, a screen, a lamp (LED), a graphical user interface (GUI), and/or even lighted keyboards) through visual, auditory, and/or other tactile cues.

Radio 524 represents a radio that facilitates communication with a wireless telecommunications network. Illustrative wireless telecommunications technologies include CDMA, GPRS, TDMA, GSM, and the like. Radio 524 might additionally or alternatively facilitate other types of wireless communications including Wi-Fi, WiMAX, LTE, 3G, 4G, LTE, mMIMO/5G, NR, VOLTE, or other VoIP communications. As can be appreciated, in various embodiments, radio 524 can be configured to support multiple technologies and/or multiple radios can be utilized to support multiple technologies. A wireless telecommunications network might include an array of devices, which are not shown so as to not obscure more relevant aspects of the invention. Components such as a base station, a communications tower, or even access points (as well as other components) can provide wireless connectivity in some embodiments.

The input/output (I/O) ports 518 may take a variety of forms. Exemplary I/O ports may include a USB jack, a stereo jack, an infrared port, a firewire port, other proprietary communications ports, and the like. Input/output (I/O) components 520 may comprise keyboards, microphones, speakers, touchscreens, and/or any other item usable to directly or indirectly input data into the computing device 500.

Power supply 522 may include batteries, fuel cells, and/or any other component that may act as a power source to supply power to the computing device 500 or to other network components, including through one or more electrical connections or couplings. Power supply 522 may be configured to selectively supply power to different components independently and/or concurrently.

Many different arrangements of the various components depicted, as well as components not shown, are possible without departing from the scope of the claims below. Embodiments of our technology have been described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

What is claimed is:

1. A system for providing network notification, the system comprising:
one or more processors; and
one or more computer-readable media storing computer-usable instructions that, when executed by the one or more processors, cause the one or more processors to:
receive an indication of a triggering event;
identify a location of the triggering event;
create a distribution list of one or more network nodes within a predetermined distance of the location of the triggering event to receive a notification of the triggering event; and
communicate the notification to the one or more network nodes within the predetermined distance of the location of the triggering event.

2. The system of claim 1, wherein the indication of the triggering event is received by one or more sensors or a sensor array.

3. The system of claim 2, wherein the one or more sensors comprises an acoustic sensor.

4. The system of claim 2, wherein the one or more sensors comprises a camera sensor.

5. The system of claim 2, wherein the one or more sensors comprises a weather sensor.

6. The system of claim 1, wherein the notification comprises a recommended action.

7. The system of claim 6, wherein the recommended action is to evacuate an area within the predetermined distance from the triggering event.

8. A method for providing network notification, the method comprising:
receiving an indication of a triggering event;
identifying a location of the triggering event;
creating a distribution list of one or more network nodes within a predetermined distance of the location of the triggering event to receive a notification of the triggering event; and
communicating the notification to the one or more network nodes within the predetermined distance of the location of the triggering event.

9. The method of claim 8, wherein the indication of the triggering event is received by one or more sensors or a sensor array.

10. The method of claim 9, the one or more sensors comprises an acoustic sensor.

11. The method of claim 9, wherein the one or more sensors comprises a camera sensor and a water level sensor.

12. The method of claim 8, wherein the notification comprises a recommended action.

13. The method of claim 12, wherein the recommended action is to evacuate an area within the predetermined distance from the triggering event.

14. The method of claim 8, further comprising determining an area that is a second predetermined distance from the triggering event, wherein the second predetermined distance is further than the predetermined distance from the triggering event.

15. The method of claim 14, further comprising communicating a second notification to different set of one or more network nodes within a second predetermined distance from the triggering event.

16. The method of claim 15, wherein the second notification to the different set of one or more network nodes within the second predetermined distance is communicated subsequent to the notification to the one or more network nodes within the predetermined distance of the location of the triggering event.

17. A method for providing network notification the method comprising:
receiving an indication of a triggering event;
identifying a location of the triggering event;
identifying a first area within a first predetermined distance of the triggering event;
creating a distribution list of a first set of one or more network nodes in the first area;
communicating a first notification of the triggering event to the first set of one or more network nodes in the first area;
identifying a second area within a second predetermined distance of the triggering event, wherein the second predetermined distance is further from the location of the triggering event than the first predetermined distance;
creating a second distribution list with a second set of one or more network nodes in the second area; and
communicating a second notification of the triggering event to the second set of one or more network nodes in the second area.

18. The method of claim 17, wherein the triggering event is a natural disaster.

19. The method of claim 17, wherein the triggering event is detected by a weather sensor.

20. The method of claim 17, wherein the second area is determined based on a predicted path of the triggering event.
